(19) United States
(12) Patent Application Publication
(10) Pub. No.: US 2017/0297459 A1
(43) Pub. Date: Oct. 19, 2017

(54) MULTI-CHANNEL SEAT MOUNTING WIRE RETENTION BRACKET

(71) Applicant: GM GLOBAL TECHNOLOGY OPERATIONS LLC, Detroit, MI (US)

(72) Inventors: Matthew P. Simonin, Ortonville, MI (US); Robert N. Saje, Shelby Township, MI (US); Charles E. Jensen, Shelby Township, MI (US); Jonathan E. Rich, Macomb Township, MI (US)

(73) Assignee: GM GLOBAL TECHNOLOGY OPERATIONS LLC, Detroit, MI (US)

(21) Appl. No.: 15/130,400

(22) Filed: Apr. 15, 2016

(51) Int. Cl. B60N 2/42; B60N 2/22

(52) U.S. Cl. CPC B60N 2/4249; B60N 2/2245

(57) ABSTRACT

A multi-channel seat mounting wire retention bracket for a vehicle subjectable to an external force event and including a body structure and a seat having a seat mounting wire includes a body structure attachment portion and a wire retention portion. The body structure attachment portion is attachable to the body structure. The wire retention portion is configured to form a wire installation channel and a wire catch channel. The wire installation channel is configured to receive and retain the seat mounting wire when the seat is installed in the vehicle and to allow removal of the seat mounting wire when the seat is removed from the vehicle. The wire catch channel is configured to receive and retain the seat mounting wire during the external force event.

### TECHNICAL FIELD

This disclosure relates to a multi-channel seat mounting wire retention bracket.

### BACKGROUND

A vehicle typically includes a body structure and a seat. The seat may have a seat mounting wire. The seat mounting wire may be connected to the body structure via a seat mounting wire retention bracket attached to the body structure.

### SUMMARY

A multi-channel seat mounting wire retention bracket and a vehicle are provided herein. The multi-channel seat mounting wire retention bracket is for a vehicle subjectable to an external force event and including a body structure and a seat having a seat mounting wire. The seat mounting wire retention bracket includes a body structure attachment portion and a wire retention portion. The body structure attachment portion is attachable to the body structure. The wire retention portion is configured to form a wire installation channel and a wire catch channel. The wire installation channel is configured to receive and retain the seat mounting wire when the seat is installed in the vehicle and to allow removal of the seat mounting wire when the seat is removed from the vehicle. The wire catch channel is configured to receive and retain the seat mounting wire during the external force event.

The wire installation channel includes an upper portion having an open end, a lower portion disposed below the upper portion and having a closed end, and an intermediate portion disposed between the upper and lower portions. The seat mounting wire is receivable in the open end of the upper portion of the wire installation channel and is retainable in the closed end of the lower portion of the wire installation channel when the seat is installed in the vehicle. The wire catch channel includes a rear portion having an open end, open to the intermediate portion of the wire installation channel, and a front portion disposed forward of the rear portion and having a closed end. The seat mounting wire is moveable from the closed end of the lower portion of the wire installation channel to the closed end of the front portion of the wire catch channel during the external force event such that the seat mounting wire is retainable in the seat mounting wire retention bracket during the external force event.

The vehicle is subjectable to an external force event. The vehicle includes a body structure including a seat back structure, a seat including a seat mounting wire, and a seat mounting wire retention bracket. The seat mounting wire retention bracket includes a body structure attachment portion and a wire retention portion. The body structure attachment portion is attached to the body structure. The wire retention portion is configured to form a wire installation channel and a wire catch channel. The wire installation channel is configured to receive and retain the seat mounting wire when the seat is installed in the vehicle and to allow removal of the seat mounting wire when the seat is removed from the vehicle. The wire catch channel is configured to receive and retain the seat mounting wire during the external force event.

The wire installation channel includes an upper portion having an open end, a lower portion disposed below the upper portion and having a closed end, and an intermediate portion disposed between the upper and lower portions. The seat mounting wire is received in the open end of the upper portion of the wire installation channel and retained in the closed end of the lower portion of the wire installation channel when the seat is installed in the vehicle. The wire catch channel includes a rear portion having an open end, open to the intermediate portion of the wire installation channel, and a front portion disposed forward of the rear portion and having a closed end. The seat mounting wire moves from the closed end of the lower portion of the wire installation channel to the closed end of the front portion of the wire catch channel during the external force event such that the seat mounting wire is retained in the seat mounting wire retention bracket during the external force event.

The multi-channel seat mounting wire retention bracket and the vehicle disclosed herein retain the seat mounting wire in the seat mounting wire retention bracket during an external force event. This disclosure applies to any machine or manufacture, either stationary or mobile, requiring retention of a mounting wire during an external force event. This disclosure applies to any vehicle, including but not limited to cars, trucks, vans, busses, boats, planes, trains, manufacturing vehicles and equipment, construction vehicles and equipment, maintenance vehicles and equipment, and military vehicles and equipment.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a fragmentary, schematic, perspective illustration of a vehicle including the multi-channel seat mounting wire retention bracket of this disclosure.

FIG. 2 is a fragmentary, schematic, perspective illustration of the vehicle of FIG. 1, showing greater detail in the area of the multi-channel seat mounting wire retention bracket.

FIG. 3A is a schematic, perspective illustration of a first embodiment of the multi-channel seat mounting wire retention bracket of FIG. 1, including a seat mounting wire shown in a received position.

FIG. 3B is a schematic, perspective illustration of the first embodiment of the multi-channel seat mounting wire retention bracket of FIG. 1, including the seat mounting wire shown in an installed position prior to an external force event.

FIG. 3C is a schematic, perspective illustration of the first embodiment of the multi-channel seat mounting wire retention bracket of FIG. 1, including the seat mounting wire in a retained position during the external force event.

FIG. 4 is a schematic, side view illustration of a second embodiment of the multi-channel seat mounting wire retention bracket of FIG. 1.

FIG. 5 is a schematic, perspective illustration of a third embodiment of the multi-channel seat mounting wire retention bracket of FIG. 1.

FIG. 6A is a schematic, perspective illustration of a fourth embodiment of the multi-channel seat mounting wire retention bracket of FIG. 1.

FIG. 6B is a schematic, perspective illustration of the fourth embodiment of the multi-channel seat mounting wire retention bracket of FIG. 1, viewed from above.

FIG. 7 is a schematic, perspective illustration of a fifth embodiment of the multi-channel seat mounting wire retention bracket of FIG. 1.

FIG. 8A is a schematic, perspective illustration of a sixth embodiment of the multi-channel seat mounting wire retention bracket of FIG. 1, including the seat mounting wire shown in the received position.

FIG. 8B is a schematic, perspective illustration of the sixth embodiment of the multi-channel seat mounting wire retention bracket of FIG. 1, including the seat mounting wire shown in the installed position prior to the external force event.

FIG. 8C is a schematic, perspective illustration of the sixth embodiment of the multi-channel seat mounting wire retention bracket of FIG. 1, including the seat mounting wire in the retained position during the external force event.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims.

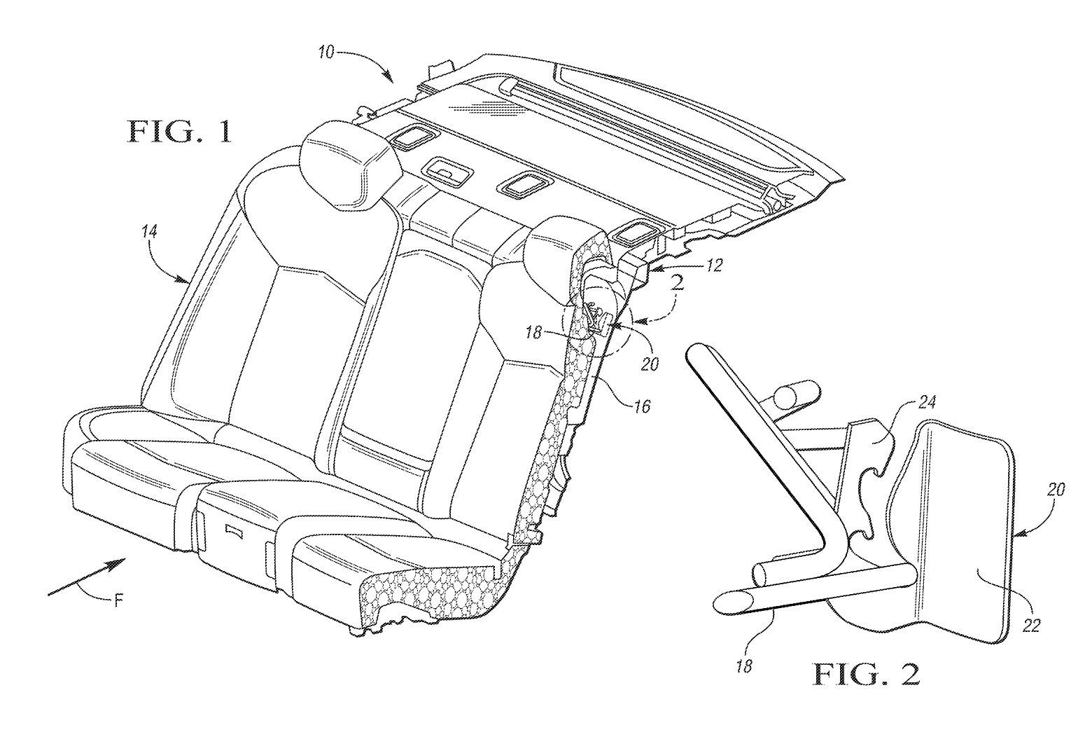

Referring to the drawings, wherein like reference numbers refer to like components throughout the views, FIG. 1 shows a portion of an example vehicle 10. The vehicle 10 is subjectable to an external force event (arrow F). The external force event (arrow F) may cause an acceleration (not shown) of the vehicle 10 and its components in the direction of the external force (arrow F). The vehicle 10 includes a body structure 12 and a seat 14. The body structure 12 may include a seat back structure 16. The seat 14 includes a seat mounting wire 18. The vehicle 10 includes a multi-channel seat mounting wire retention bracket 20, as disclosed herein.

While the vehicle 10 of FIG. 1 is a typical example application suitable for the multi-channel seat mounting wire retention bracket 20 as disclosed herein, the present design is not limited to vehicular applications. Any stationary or mobile, machine or manufacture requiring retention of an object having a mounting wire during an external force event may benefit from use of the present design, when properly scaled and configured for the particular application. For illustrative consistency, the vehicle 10 will be described hereinafter as an example system without limiting use of the multi-channel seat mounting wire retention bracket 20 as disclosed herein to such an embodiment.

Referring now to FIGS. 1-2, the seat mounting wire retention bracket 20 includes a body structure attachment portion 22 and a first wire retention portion 24. The body structure attachment portion 22 is attached to the body structure 12. The body structure attachment portion 22 may be attached to the body structure 12 via a weld, a mechanical fastener, or any other suitable attachment. The body structure attachment portion 22 may be attached to the seat back structure 16 of the body structure 12, as shown.

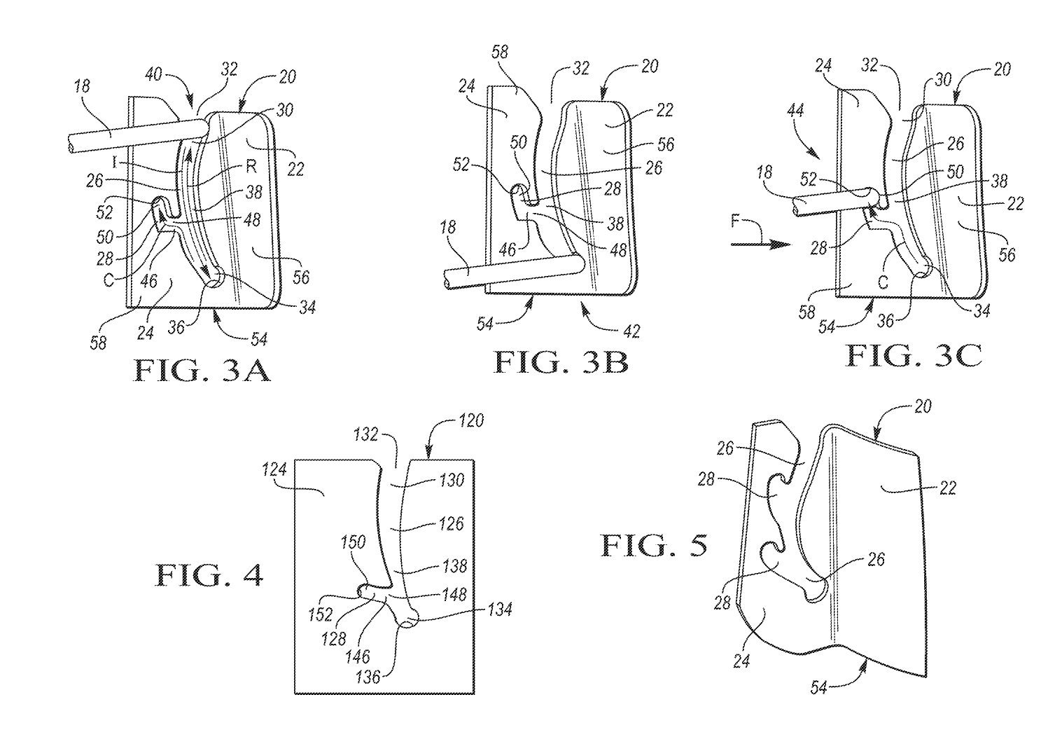

Referring now to FIGS. 3A-3B, the first wire retention portion 24 is configured to form a wire installation channel 26 and a runoff or wire catch channel 28. The wire installation channel 26 is configured to receive and retain the seat mounting wire 18 when the seat 14 is installed in the vehicle 10 by an operator (not shown). This is accomplished by the operator moving the seat mounting wire 18 of the seat 14 into and along an installation path (arrow I) from a received position 40, shown in FIG. 3A, to an installed position 42, shown in FIG. 3B. The wire installation channel 26 is also configured to allow removal of the seat mounting wire 18 of the seat 14 when the seat 14 is removed from the vehicle 10 by the operator. This is accomplished by the operator moving the seat mounting wire 18 of the seat 14 along a removal path (arrow R) from the installed position 42, shown in FIG. 3B, to the received position 40, shown in FIG. 3A, and out of the seat mounting wire retention bracket 20.

The wire installation channel 26 includes an upper portion 30 having an open end 32, a lower portion 34 disposed in elevation below the upper portion 30 and having a closed end 36, and an intermediate portion 38 disposed in elevation between the upper portion 30 and the lower portion 34. The seat mounting wire 18 is received in the open end 32 of the upper portion 30 of the wire installation channel 26, as shown in FIG. 3A, and is retained in the closed end 36 of the lower portion 34 of the wire installation channel 26, as shown in FIG. 3B, when the seat 14 is installed in the vehicle 10.

Continuing to refer to FIGS. 3A-3B, the upper portion 30 and the intermediate portion 38 of the wire installation channel 26 of the wire retention bracket 20 may be configured such that the seat mounting wire 18 of the seat 14 can be moved by the operator along the installation path (arrow I) and the removal path (arrow R) without interference between the seat mounting wire 18 and the wire retention bracket 20. The closed end 36 of the lower portion 34 of the wire installation channel 26 may be configured to conform to the seat mounting wire 18 such that movement of the seat mounting wire 18 relative to the seat mounting wire retention bracket 20 is prevented under normal operating conditions of the vehicle 10, thus preventing rattles, squeaks, vibrations, and/or other noises.

The closed end 36 of the lower portion 34 of the wire installation channel 26 may be in an interference fit relationship with the seat mounting wire 18 when the seat mounting wire 18 is in the installed position 42. An interference fit relationship is defined herein as a connection between two parts which is achieved by friction of respective conforming surfaces of the two parts after the two parts are pushed together. The closed end 36 of the lower portion 34 of the wire installation channel 26 may be in a location fit relationship with the seat mounting wire 18 when the seat mounting wire 18 is in the installed position 42. A location fit relationship is defined herein as a connection between two parts which is achieved by positioning respective closely conforming surfaces of the two parts together precisely, yet not so tightly that they cannot be easily disassembled. The seat mounting wire retention bracket 20 may be configured to allow installation and removal of the seat 14 by the operator without tools or additional moving parts.

Continuing to refer to FIGS. 3B-3C, the runoff or wire catch channel 28 is configured to receive and retain the seat mounting wire 18 during the external force event (arrow F). The external force event (arrow F) causes the seat mounting wire 18 of the seat 14 to move along a catch path (arrow C) from the installed position 42, as shown in FIG. 3B, to a retained position 44, as shown in FIG. 3C. The runoff or wire catch channel 28 includes a rear portion 46 and a front portion 50. The rear portion 46 of the wire catch channel 28 has an open end 48. The open end 48 of the rear portion 46 of the wire catch channel 28 is open to the intermediate portion 38 of the wire installation channel 26. The front portion 50 of the wire catch channel 28 disposed forward of the rear portion 46 of the wire catch channel 28 and has a closed end 52.

The seat mounting wire 18 moves from the closed end 36 of the lower portion 34 of the wire installation channel 26, as shown in FIG. 3B, to the closed end 52 of the front portion 50 of the wire catch channel 28, as shown in FIG. 3C, during the external force event (arrow F) such that the seat mounting wire 18 is retained in the seat mounting wire retention bracket 20 during the external force event (arrow F). The seat mounting wire 18 may be mechanically locked in the closed end 52 of the front portion 50 of the wire catch channel 28 during the external force event (arrow F) such that the seat mounting wire 18 is retained in the seat mounting wire retention bracket 20 during the external force event (arrow F).

Referring again to FIGS. 3A-3C, the intermediate portion 38 of the wire installation channel 26 may be further disposed forward of both the upper portion 30 and the lower portion 34 of the wire installation channel 26. The wire installation channel 26 may have a smooth open C-shape, as shown. The wire installation channel 26 may have other shapes, as appropriate. The closed end 52 of the front portion 50 of the wire catch channel 28 may be disposed in elevation above the open end 48 of the rear portion 46 of the wire catch channel 28, as shown. Alternatively, the closed end 52 of the front portion 50 of the wire catch channel 28 may be disposed in elevation similar to the open end 48 of the rear portion 46 of the wire catch channel 28.

The seat mounting wire retention bracket 20 may be configured to include an L-shaped bracket 54 in a plan view cross-section having a base 56 and a side 58, as shown. Plan view is defined herein as a view in a direction normal to a plane of a road or ground that the vehicle 10 travels on. One of the base 56 and the side 58 of the L-shaped bracket 54 may include the first body structure attachment portion 22. The other of the base 56 and the side 58 of the L-shaped bracket 54 may include the first wire retention portion 24.

Referring now to FIG. 4, in another embodiment of a seat mounting wire retention bracket 120, a closed end 152 of a front portion 150 of a runoff or wire catch channel 128 may be disposed in elevation similar to or the same as open end 148 of a rear portion 146 of the wire catch channel 128.

Referring now to FIG. 5, in another embodiment of the seat mounting wire retention bracket 20, the first wire retention portion 24 may be configured to form a plurality of wire catch channels 28 configured to receive and retain the seat mounting wire 18 of the seat 14 during the external force event (arrow F).

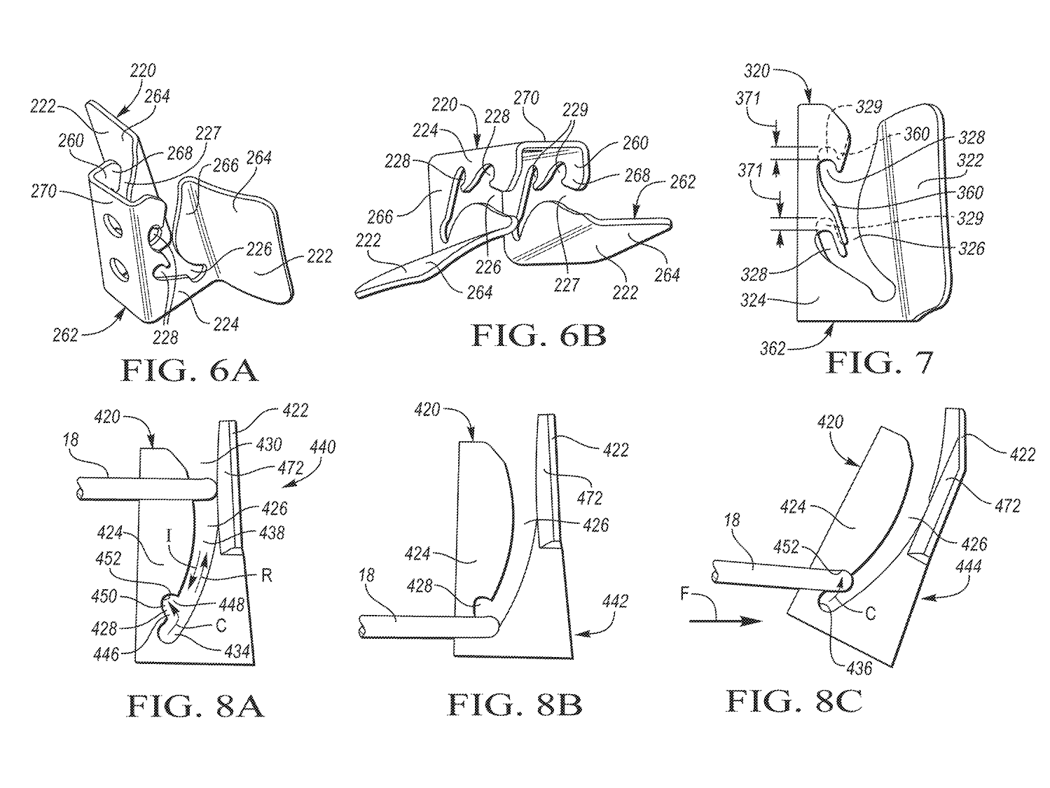

Referring now to FIGS. 6A-6B, in another embodiment, a seat mounting wire retention bracket 220 may further comprise a second wire retention portion 260 having a second wire installation channel 227 and a second wire catch channel 229. The seat mounting wire retention bracket 220 may be configured to include a hat-shaped bracket 262 in a plan view cross-section. Hat-shaped is defined herein as the shape of a cross-section through the center of a top hat on a plane that is normal to the ground. The hat-shaped bracket 262 may have a brim 264, a first side 266, a second side 268, and a top 270. The brim 264 of the hat-shaped bracket 262 may include a body structure attachment portion 222. Both portions of the brim 264 of the hat-shaped bracket 262 may include the body structure attachment portion 222. The first side 266 of the hat-shaped bracket 262 may include a first wire retention portion 224 and the second side 268 of the hat-shaped bracket 262 may include the second wire retention portion 260. The configuration of the second wire retention portion 260 may be identical to the configuration of the first wire retention portion 224, as shown. The first wire retention portion 224 and the second wire retention portion 260 may be configured to form a plurality of wire catch channels 228, 229 as shown.

Referring now to FIG. 7, in another embodiment of a seat mounting wire retention bracket 320, the configuration of a second wire retention portion 360 of a hat shaped bracket 362 may be identical to the configuration of a first wire retention portion 324 of the hat shaped bracket 362, except that a second wire catch channel 329 of the second wire retention portion 360 may be disposed above a wire catch channel 328 of the first wire retention portion 324 in elevation, as shown. The wire catch channel 329 of the second wire retention portion 360 may be disposed above the wire catch channel 328 of the first wire retention portion 324 in elevation by an offset distance 371. The offset distance 371 may be any suitable distance. The first wire retention portion 324 and the second wire retention portion 360 may be configured to form a plurality of wire catch channels 328, 329, as shown.

Referring now to FIGS. 8A-8C, in another embodiment of a seat mounting wire retention bracket 420, a lower portion 434 of a wire installation channel 426 may be further disposed forward of both an upper portion 430 and an intermediate portion 438 of the wire installation channel 426. The wire installation channel 426 may have a smooth open J-shape, as shown. The wire installation channel 426 may have other shapes, as appropriate. A closed end 452 of a front portion 450 of a wire catch channel 428 may be disposed in elevation above an open end 448 of a rear portion 446 of the wire catch channel 428, as shown. Alternatively, the closed end 452 of the front portion 450 of the wire catch channel 428 may be disposed in elevation similar to or the same as the open end 448 of the rear portion 446 of the wire catch channel 428.

The seat mounting wire retention bracket 420 may include a deformation portion 472. The deformation portion 472 may be disposed in elevation below a body structure attachment portion 422. The deformation portion 472 may be configured to deform during the external force event (arrow F), as shown in FIG. 8C. FIG. 8A shows the seat mounting wire 18 in a received position 440. FIG. 8B shows the seat mounting wire in an installed position 442. And, FIG. 8C shows the seat mounting wire 18 in a retained position 444 when the deformation position 472 is deformed during the external force event (arrow F). It will be recognized by those skilled in the art, that the embodiment of the mounting wire retention bracket 420 shown in FIGS. 8A-8C may be configured to include the L-shaped bracket 54, of FIGS. 3A-3C, the hat-shaped bracket 262, 362 of FIGS. 6A-7, and/or the plurality of wire catch channels 28, 228, 229, 328, and 329, of FIGS. 5-7.

While the best modes for carrying out the many aspects of the present teachings have been described in detail, those familiar with the art to which these teachings relate will recognize various alternative aspects for practicing the present teachings that are within the scope of the appended claims.

1. A seat mounting wire retention bracket for a vehicle subjectable to an external force event and including a body structure and a seat having a seat mounting wire, the seat mounting wire retention bracket comprising:
a body structure attachment portion attachable to the body structure; and
a first wire retention portion configured to form:
a wire installation channel configured to receive and retain the seat mounting wire when the seat is installed in the vehicle and to allow removal of the seat mounting wire when the seat is removed from the vehicle; and
a wire catch channel configured to receive and retain the seat mounting wire during the external force event;
wherein the wire installation channel includes an upper portion having an open end, a lower portion disposed in elevation below the upper portion and having a closed end, and an intermediate portion disposed between the upper portion and the lower portion;
wherein the seat mounting wire is receivable in the open end of the upper portion of the wire installation channel and retainable in the closed end of the lower portion of the wire installation channel when the seat is installed in the vehicle;
wherein the wire catch channel includes a rear portion having an open end, open to the intermediate portion of the wire installation channel, and a front portion disposed forward of the rear portion and having a closed end; and
wherein the seat mounting wire is moveable from the closed end of the lower portion of the wire installation channel to the closed end of the front portion of the wire catch channel during the external force event such that the seat mounting wire is retainable in the seat mounting wire retention bracket during the external force event.

2. The seat mounting wire retention bracket of claim 1, wherein the intermediate portion of the wire installation channel is further disposed forward of both the upper and lower portions of the wire installation channel; and
wherein the wire installation channel has a smooth open C-shape.

3. The seat mounting wire retention bracket of claim 2, wherein the closed end of the front portion of the wire catch channel is further disposed in elevation above the open end of the rear portion of the wire catch channel.

4. The seat mounting wire retention bracket of claim 2, wherein the seat mounting wire retention bracket is configured to include an L-shaped bracket in a plan view cross-section having a base and a side;
wherein one of the base and the side of the L-shaped bracket includes the body structure attachment portion; and
wherein the other of the base and the side of the L-shaped bracket includes the first wire retention portion.

5. The seat mounting wire retention bracket of claim 2, wherein the wire retention bracket further comprises a second wire retention portion;
wherein the seat mounting wire retention bracket is configured to include a hat-shaped bracket in a plan view having a brim, a first side, a second side, and a top;
wherein the brim of the hat-shaped bracket includes the body structure attachment portion;
wherein the first side of the hat-shaped bracket includes the first wire retention portion; and
wherein the second side of the hat-shaped bracket includes the second wire retention portion.

6. The seat mounting wire retention bracket of claim 5, wherein the configuration of the second wire retention portion is identical to the configuration of the first wire retention portion.

7. The seat mounting wire retention bracket of claim 5, wherein the configuration of the second wire retention portion is identical to the configuration of the first wire retention portion except that the wire catch channel of the second wire retention portion is disposed above the wire catch channel of the first wire retention portion in elevation.

8. The seat mounting wire retention bracket of claim 1, wherein the lower portion of the wire installation channel is further disposed forward of both the upper and intermediate portions of the wire installation channel; and
wherein the wire installation channel has a smooth open J-shape.

9. The seat mounting wire retention bracket of claim 8, wherein the closed end of the front portion of the wire catch channel is further disposed in elevation above the open end of the rear portion of the wire catch channel.

10. The seat mounting wire retention bracket of claim 8, wherein the seat mounting wire retention bracket further comprises a deformation portion;
wherein the deformation portion is configured to deform during the external force event.

11. The seat mounting wire retention bracket of claim 10, wherein the seat mounting wire retention bracket is configured to include an L-shaped bracket in a plan view having a base and a side;
wherein one of the base and the side of the L-shaped bracket includes the body structure attachment portion; and
wherein the other of the base and the side of the L-shaped bracket includes the first wire retention portion.

12. The seat mounting wire retention bracket of claim 10, wherein, the seat mounting wire retention bracket further comprises a second wire retention portion;
wherein the seat mounting wire retention bracket is configured to include a hat-shaped bracket in a plan view cross-section having a brim, a first side, a second side, and a top;
wherein the brim of the hat-shaped bracket includes the body structure attachment portion;
wherein the first side of the hat-shaped bracket includes the first wire retention portion; and
wherein the second side of the hat-shaped bracket includes the second wire retention portion.

13. The seat mounting wire retention bracket of claim 10, wherein the configuration of the second wire retention portion is identical to the configuration of the first wire retention portion.

14. The seat mounting wire retention bracket of claim 10, wherein the configuration of the second wire retention portion is identical to the configuration of the first wire retention portion except that the wire catch channel of the second wire retention portion is above the wire catch channel of the first wire retention portion in elevation.

15. The seat mounting wire retention bracket of claim 1, wherein the first wire retention portion is configured to form a plurality of wire catch channels configured to receive and retain the seat mounting wire during the external force event.

16. A vehicle subjectable to an external force event, comprising:
a body structure including a seat back structure;
a seat including a seat mounting wire; and
a seat mounting wire retention bracket, including:
a body structure attachment portion attached to the body structure; and
a first wire retention portion configured to form:
a wire installation channel configured to receive and retain the seat mounting wire when the seat is installed in the vehicle and to allow removal of the seat mounting wire when the seat is removed from the vehicle; and
a wire catch channel configured to receive and retain the seat mounting wire during the external force event;
wherein the wire installation channel includes an upper portion having an open end, a lower portion disposed in elevation below the upper portion and having a closed end, and an intermediate portion disposed between the upper portion and the lower portion;
wherein the seat mounting wire is received in the open end of the upper portion of the wire installation channel and retained in the closed end of the lower portion of the wire installation channel when the seat is installed in the vehicle;
wherein the wire catch channel includes a rear portion having an open end, open to the intermediate portion of the wire installation channel, and a front portion disposed forward of the rear portion and having a closed end; and
wherein the seat mounting wire moves from the closed end of the lower portion of the wire installation channel to the closed end of the front portion of the wire catch channel during the external force event such that the seat mounting wire is retained in the seat mounting wire retention bracket during the external force event.

17. The vehicle of claim 16, wherein the intermediate portion of the wire installation channel is further disposed forward of both the upper and lower portions of the wire installation channel;
wherein the wire installation channel has a smooth open C-shape; and
wherein the closed end of the front portion of the wire catch channel is further disposed in elevation above the open end of the rear portion of the wire catch channel.

18. The vehicle of claim 16, wherein the seat mounting wire retention bracket further comprises a deformation portion;
wherein the deformation portion is configured to deform during the external force event;
wherein the lower portion of the wire installation channel is further disposed forward of both the upper and intermediate portions of the wire installation channel;
wherein the wire installation channel has a smooth open J-shape; and
wherein the closed end of the front portion of the wire catch channel is further disposed in elevation above the open end of the rear portion of the wire catch channel.

19. The vehicle of claim 16, wherein the wire retention portion is configured to form a plurality of wire catch channels configured to receive and retain the seat mounting wire during the external force event.

20. The vehicle of claim 16, wherein the seat mounting wire retention bracket further comprises a second wire retention portion; and
wherein the configuration of the second wire retention portion is identical to the configuration of the first wire retention portion.
